(19) United States
(12) Patent Application Publication
(10) Pub. No.: US 2026/0259371 A1
(43) Pub. Date: Sep. 3, 2026

(54) Surface Coupling and Optical Beam Expansion System in a Photonic Integrated Circuit

(71) Applicant: IMEC VZW, Leuven (BE)

(72) Inventors: Cheng-Jhih Luo, Leuven (BE); Chia-Ning Weng, Heverlee (BE); Joris Van Campenhout, Leuven (BE); Maumita Chakrabarti, Kessel-lo (BE); Yosuke Shimura, Leuven (BE); Guy Lepage, Langdorp (BE)

(21) Appl. No.: 19/551,967

(22) Filed: Feb. 27, 2026

(30) Foreign Application Priority Data
Feb. 28, 2025 (EP) 25160800.6

(51) Int. Cl. G02B 6/122; G02B 6/12; G02B 6/13

(52) U.S. Cl. CPC G02B 6/1228; G02B 6/131; G02B 2006/12102; G02B 2006/12104

(57) ABSTRACT

The present disclosure provides an integrated photonic chip for optical coupling. The photonic chip includes a substrate, a spot size converter formed on a frontside surface of the substrate, a mirror formed on the frontside surface of the substrate, and a meta-lens formed in or on a backside surface of the substrate. The spot size converter enlarges a diameter of a light beam in the photonic chip from a smaller mode size to a larger mode size. The mirror receives the larger mode size light beam from the spot size converter, and reflects the light beam at an angle into the substrate. The meta-lens collimates the light beam reflected by the mirror and expanded, when passing through the substrate, and outputs the collimated light beam towards the optical device.

### CROSS-REFERENCE TO RELATED APPLICATION(S)

The present application is a non-provisional patent application claiming priority to European Patent Application No. 25160800.6, filed Feb. 28, 2025, the contents of which are hereby incorporated by reference.

### FIELD OF THE DISCLOSURE

The present disclosure relates to photonic chips or integrated circuits (PICs) and optical coupling. The disclosure provides an integrated photonic chip for optical coupling to an optical device, for example, to an optical fiber device or an optical device with an on-device waveguide. The photonic chip of the present disclosure provides (e.g., employs) surface coupling and optical beam expansion.

### BACKGROUND

Optical input/output (I/O) and interconnection technologies may improve signal transmission between integrated circuit (IC) nodes. Vertically stacked assemblies for both electrical and optical components may be implemented at the wafer level. Ultimately, the transmitted signals may be delivered to a fiber array connector for long-distance transmission. The coupling interface between a photonic chip (PIC) and a fiber array connector facilitates low-loss, reliable packaging.

Conventional surface-coupling approaches for PICs often rely on fiber grating couplers, which may be (e.g., inherently) limited by their optical spectral bandwidth and small mode field diameter for a single mode operation. An alternative is optical beam expansion, which enlarges and collimates the light beam from the PIC before reaching the fiber array connector. Expanding the beam diameter—(e.g., often) to tens of microns—increases mechanical alignment tolerances, and thus facilitates pluggable designs. Also, the overall robustness and performance are improved.

However, conventional beam expansion techniques often use (e.g., require) complex processing and bonding steps during fabrication, and usually do not employ full wafer-level integration flows.

### SUMMARY

In view of the above, the present disclosure provides an integrated photonic chip for surface coupling and uses beam expansion. A full wafer-level integration flow would be useful, without optical spectral bandwidth issues.

These and other improvements are provided in the present disclosure. Example embodiments are described in the dependent claims.

A first example embodiment of the present disclosure provides an integrated photonic chip (PIC) for optical coupling to an optical device. The integrated photonic chip includes a substrate. The integrated photonic chip includes a spot size converter formed on a frontside (e.g., first) surface of the substrate and configured to enlarge a diameter of a light beam in the photonic chip from a smaller mode size (e.g., first size) to a larger mode size (e.g., second size). The integrated photonic chip includes a mirror formed on the frontside surface of the substrate and configured to receive the larger mode size light beam from the spot size converter and to reflect the light beam at an angle into the substrate. The integrated photonic chip includes a meta-lens formed in or on a backside (e.g., second) surface of the substrate and configured to collimate the light beam, which is reflected by the mirror and expanded when passing through the substrate, and output the collimated light beam towards the optical device.

Accordingly, the present disclosure proposes a surface-coupling interface between the photonic chip of the first example embodiment and the optical device. The optical device may be a fiber array connector. According to the present disclosure, the mirror is integrated with the meta-lens to implement a micro-optical beam expansion and collimation system. This may be provided by an integration flow and provides improved coupling performance of the photonic chip. Moreover, spot size conversion is provided. Separately providing (e.g., defining) the spot size converter and the mirror provides (e.g., good) system flexibility, for example, on the choice of waveguide material, and provides (e.g., allows) mode field shaping for the beam expansion.

The mirror and meta-lens fabrication may be (e.g., well) integrated into silicon photonics process flows. If the mirror is fabricated from silicon, an (e.g., good) angle control of the mirror angles is possible, and a cost-effective process flow may be set up.

In an example embodiment, the photonic chip further includes a first anti-reflection layer arranged in the optical path of the light beam between the spot size converter and the mirror, and/or a second anti-reflection layer arranged in or on the backside surface of the substrate.

Generally, a respective anti-reflection layer may be integrated at any interface between different materials in the photonic chip of the first example embodiment, to enhance efficiency.

In an example embodiment of the photonic chip, the spot size converter and the mirror are embedded in a dielectric layer arranged on the frontside surface of the substrate.

In an example embodiment of the photonic chip, the mirror is made of (e.g., provided in the form of) crystalline silicon, for example, epitaxial silicon or a silicon part of the substrate.

Thus, improved mirror angle control capability and a cost-effective process flow are provided.

In an example embodiment of the photonic chip, the mirror includes a first vertical surface facing the spot size converter and a first sloped surface facing away from the spot size converter.

In an example embodiment of the photonic chip, the first anti-reflection layer is an anti-reflection coating provided on the first flat surface and facing the spot size converter.

In an example embodiment of the photonic chip, the mirror includes a second vertical surface facing away from the spot size converter and a second sloped surface facing the spot size converter. The first sloped surface and the second sloped surface are arranged between the first vertical surface and the second vertical surface.

In an example embodiment of the photonic chip, an angle between (e.g., respectively) the first vertical surface and the first sloped surface and/or the second vertical surface and the second sloped surface is determined by a crystalline orientation of the mirror material and/or is in a range of about 35° to about 45°.

For example, the angle may be determined by a crystalline orientation of the mirror material, e.g., epitaxial silicon. As specific examples, the angle may be 35.27° or the angle may be 45°. The crystalline orientation provides (e.g., good) angle forming accuracy, which may be useful for the system control.

In an example embodiment of the photonic chip, the spot size converter includes a tapered waveguide or a wavefront shaping element, and/or the spot size converter is made of silicon nitride, silicon, or silicon oxynitride.

The spot size converter and mirror may be provided separately in the fabrication process flow, providing an improved mode-field shape engineering capability for the beam expansion system.

In an example embodiment of the photonic chip, the meta-lens includes a periodic patterning of the backside surface of the substrate.

In an example embodiment, the photonic chip further includes at least one alignment structure arranged on or formed in the backside surface of the substrate. The at least one alignment structure is configured to align the photonic chip with the optical device.

A second example embodiment of the present disclosure provides a system including the integrated photonic chip according to the first example embodiment and the optical device. The optical device includes at least one alignment structure configured to align the optical device with the photonic chip, and when the optical device is aligned with photonic chip, a collimation lens is configured to (e.g., arranged) receive the collimated light beam output of (e.g., by) the photonic chip and focus the light beam into an optical fiber or an on-device waveguide of the optical device.

The system of the second example embodiment may share the improvements of the photonic chip of the first example embodiment. For example, a surface coupling between the photonic chip and the optical device is provided, improving high mechanical alignment tolerance and coupling efficiency.

A third example embodiment of the present disclosure provides a method for fabricating an integrated photonic chip according to the first example embodiment. The method includes providing the substrate, forming the spot size converter and the mirror on the frontside surface of the substrate, and forming the meta-lens in or on the backside surface of the substrate.

The method of the third example embodiment facilitates an integration flow, for example, for full wafer level processing of the photonic chip of the first example embodiment, providing backside emission. The process flow provides (e.g., allows) for a silicon nitride (SiN) waveguide and for a spot size converter for improved mode field diameter (MFD) control.

In an example embodiment of the method, forming the mirror includes forming a trench through a dielectric layer, which is formed on the frontside surface of the substrate, onto the substrate or forming a trench into the substrate. The substrate is made of silicon. If the trench is formed through the dielectric layer, the method may include epitaxially growing crystalline silicon in (e.g., into) the trench. The method further includes wet etching the epitaxially grown silicon that was grown into the trench or wet etching the silicon substrate including the trench, to form at least one sloped surface of the mirror. The method further includes coating the at least one sloped surface of the mirror with a reflective coating.

The mirror is accordingly formed on the frontside of the substrate.

In an example embodiment of the method, forming the meta-lens includes forming a resist layer on the backside surface of the substrate, patterning the resist layer, for example, by nano-imprinting, and etching the patterned resist layer to form a structure for the meta-lens in the backside surface of the substrate.

The method of the third example embodiment may have further embodiments that correspond to the embodiments of the photonic chip of the first example embodiment. The method of the third example embodiment and its embodiments provide the improvements described above with respect to the photonic chip of the first example embodiment and its embodiments.

In summary, a photonic chip for improved optical coupling is provided according to the above example embodiments.

In the photonic chip, a photonic spot size converter is used to enlarge the MFD of the light. The spot size converter may be implemented by photonic waveguide tapering, or wavefront shaping (e.g., techniques). The material of the spot size converter may be, but not limited to, SiN or Si.

Further, an anti-reflection layer, which may be a single or multi-layer anti-reflection coating, may be used. For example, the anti-reflection layer may be provided for a (e.g., certain or predetermined) operating wavelength (e.g., the O band, with a center wavelength at 1310 nm) and propagation direction. The material choice for the anti-reflection layer includes SiN, TiO, and others.

Further, a reflection mirror may be used, which may be fabricated by a combination of crystalline silicon epitaxy and anisotropic wet etching (such as with KOH and TMAH). Chemical mechanical polishing (CMP) may be applied after the epitaxy, for flattening the mirror surfaces. A thickness of the silicon epitaxy material of the mirror may determine the mirror height, and the crystalline orientation of the mirror material may determine the mirror angle with respect to a vertical axis (e.g., aligned with the epitaxial growth direction).

Further, a substrate may be used as a carrier for the optical elements of the photonic chip. For matching a target propagation distance for beam expansion of the light field, process steps of polishing, thinning, or depositing additional material, may be performed.

An optical meta-lens of the photonic chip may be based on silicon and is used as the collimation lens. The meta-lens process may be in the backside of the substrate. The position of the meta-lens may be determined by the optical system design for optimizing the relative position to the mirror.

### BRIEF DESCRIPTION OF THE FIGURES

The above, as well as additional, features will be better understood through the following illustrative and non-limiting detailed description of example embodiments, with reference to the appended drawings.

The above described example embodiments are provided with respect to the enclosed drawings.

FIG. 1 shows an example photonic chip according to the present disclosure, with integrated spot size converter, mirror, and meta-lens.

FIG. 2 shows an example photonic chip according to the present disclosure, with anti-reflection layer(s).

FIG. 3 shows an example system according to the present disclosure, including a coupled photonic chip and optical device.

FIG. 4 shows a sequence of events regarding a light beam in the photonic chip.

FIG. 5 shows a flow-chart of a method for fabricating a photonic chip according to the present disclosure.

FIGS. 6A, 6B, 6C, 6D, and 6E show example steps for processing the meta-lens of the photonic chip.

FIGS. 7A, 7B, 7C, 7D, and 7E show example steps for processing the meta-lens of the photonic chip.

FIGS. 8A, 8B, 8C, 8D, 8E, 8F, and 8G show example steps for processing the mirror of the photonic chip.

FIG. 9A shows the simulated intensity profile of the light field for the cross-section view of the photonic chip shown in FIG. 2.

FIGS. 9B and 9C show the efficiency spectrum for the mirror, indicating what portion of the light is vertically reflected.

FIG. 10 shows an example photonic chip according to the present disclosure, with a mirror formed in a substrate.

The same elements in the figures may be labelled with the same reference signs and may be implemented likewise.

The figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

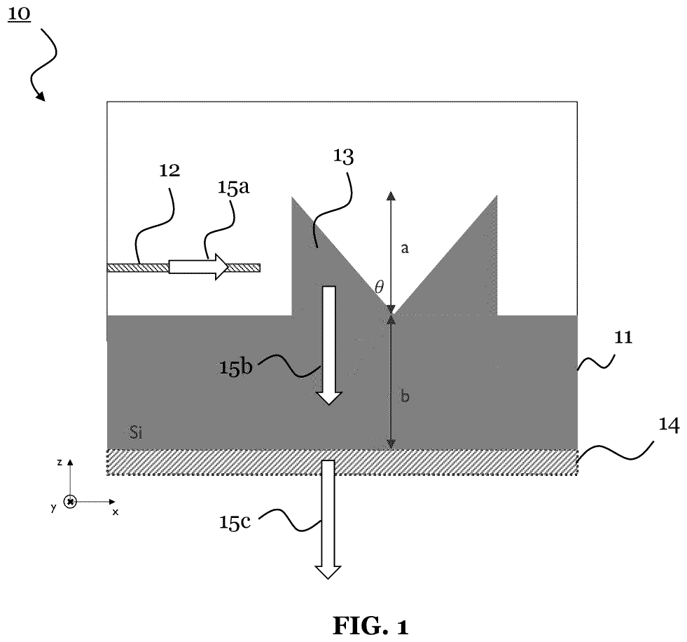

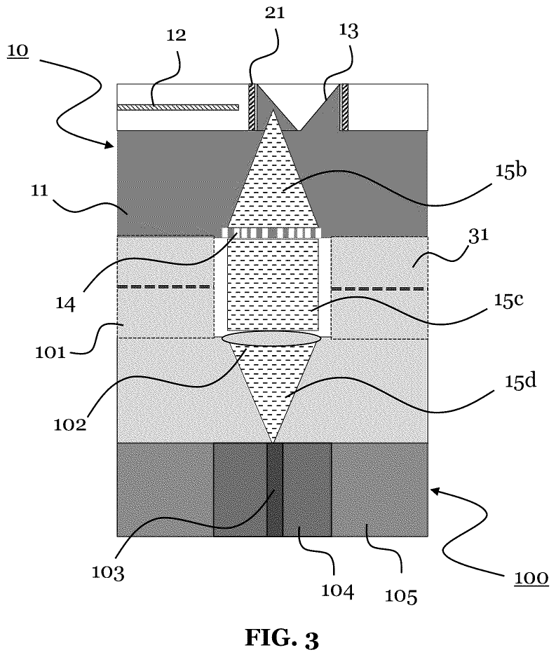

FIG. 1 shows an integrated photonic chip 10 according to the present disclosure. The photonic chip 10 is configured to optically couple to an optical device, such as the optical device 100 (shown in FIG. 3. The optical device 100 may be a fiber array connector, a fiber device, or a device with a waveguide. Light from the photonic chip 10 may be (e.g., eventually) coupled to the fiber array, fiber, or waveguide of the optical device 100.

A photonic chip, or photonic integrated circuit (PIC), is a microchip that integrates optical components—such as waveguides, lasers, modulators, and detectors—to process and transmit information using light instead of electricity. Similar to electronic integrated circuits (ICs), photonic chips facilitate high-speed data transfer, lower power consumption, and miniaturized optical systems for applications in telecommunications, data centers, sensing, and quantum computing.

The photonic chip 10 of the present disclosure includes a substrate 11, a spot-size converter 12 formed on a frontside surface of the substrate 11, a mirror 13 formed on the frontside (e.g., first) surface of the substrate 11, and a meta-lens 14 formed in or on a backside (e.g., second) surface of the substrate 11. The substrate 11 may be a silicon substrate or wafer. The frontside and backside surfaces of the substrate 11 may be two opposite surfaces of the substrate 11. The frontside may (e.g., naturally) be accessible for processing the spot size converter 12 and the mirror 13 (e.g., the exposed top surface of a wafer), while the backside surface may be accessible or is first formed by processing steps such as thinning, before processing the meta-lens 14. The spot size converter 12 and the mirror 13 may be (e.g., at least partly) embedded in a dielectric layer, which is arranged on the frontside surface of the substrate 11.

The spot size converter 12 is configured to enlarge a diameter of a light beam 15a in the photonic chip 10—schematically depicted by the arrow—from a smaller mode size to a larger mode size. The spot size converter 12 may be used to gradually enlarge the diameter, e.g., to gradually expand the optical mode. The spot size converter 12 may include a tapered waveguide or a wavefront shaping element. The spot size converter 12 may be made of silicon nitride, silicon, or silicon oxynitride.

The mirror 13 is configured to receive the larger mode size light beam 15a from the spot size converter 12, and to reflect the light beam 15a at an angle into the substrate 11. The angle may be about 90°, but may also be smaller, for example, between 10° and 90°. When passing through the substrate 11, the light beam 15a expands, and the expanded light beam 15b reaches the meta-lens 14.

The meta-lens 14 is configured to collimate the expanded light beam 15b, which was reflected by the mirror 13, and to output the collimated light beam 15c towards the optical device. The meta-lens 14 may use a nanostructured meta-surface to manipulate the light beam 15b at subwavelength scales. For example, the meta-lens 14 may include a periodic patterning of the backside surface of the substrate 11 as the meta-surface. The nanostructured meta-surface may control phase, polarization, and/or apply wavefront shaping of the light, to collimate the light beam 15c.

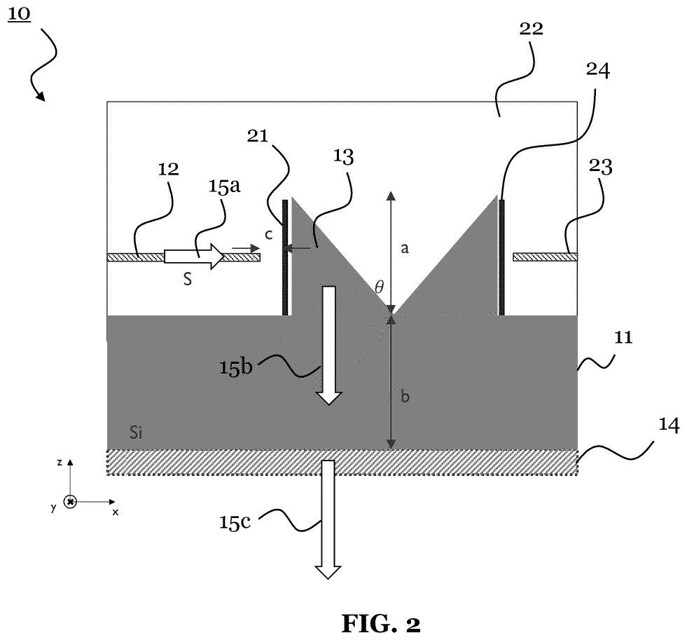

FIG. 2 shows an example photonic chip 10 according to the present disclosure, which is based on the photonic chip 10 of FIG. 1.

The photonic chip 10 of FIG. 2 further includes a first anti-reflection layer 21, which is arranged in the optical path of the light beam 15a between the spot size converter 12 and the mirror 13. With the anti-reflection layer 21, back-reflection may be controlled.

For example, the mirror 13 may include a first vertical surface facing the spot size converter 12 and a first sloped surface facing away from the spot size converter 12. For example, the first anti-reflection layer 21 may be an anti-reflection coating, which is provided on the first flat (e.g., vertical) surface and may face the spot size converter 12.

The mirror 13 may further include a second vertical surface facing away from the spot size converter 12 and a second sloped surface facing the spot size converter 12. The first and the second sloped surfaces are arranged between the first and the second vertical surfaces. The mirror 13 may be symmetrical. A anti-reflection layer 24 may be further provided on the second flat (e.g., vertical) surface and may face away from the spot size converter 12. The anti-reflection layer 24 may face another spot size converter 23 on the other side of the mirror 13.

A first angle of the mirror 13 may be provided between the first vertical surface and the first sloped surface. A second angle of the mirror 13 may be provided between the second vertical surface and the second sloped surface. The first and/or second angle may (e.g., respectively) be determined by a crystalline orientation of the mirror material and/or may (e.g., respectively) be in a range of about 35° to about 45°. The first and second angles of the mirror 13 may be (e.g., substantially) equal.

The mirror 13 may made of crystalline silicon, for example, epitaxial silicon (e.g., grown onto the substrate 11 or into a trench of the substrate 11), or a silicon part of the substrate 11 (e.g., formed from the substrate 11).

The photonic chip 10 may also include a further anti-reflection layer arranged in or on the backside surface of the substrate 11.

The spot size converter 12 and the mirror 13, in the example embodiment of FIG. 2, may be embedded in a dielectric layer 22 arranged on the frontside surface of the substrate 11. The dielectric layer 22 may be made of silicon dioxide.

For example, FIG. 2 shows an example structure of the photonic chip 10, in which total internal reflection (TIR) is utilized for a silicon mirror 13 with an interface of Si and/or SiO₂. The material of the spot size converter 12 may be SiN.

The coupling to the optical device (shown in FIG. 3) may be implemented by backside coupling. The light propagates through the silicon substrate 11. The following table summarizes example possible parameter ranges for the structure of the photonic chip 10. The ranges are determined from simulation results, which showed (e.g., good) coupling performance.

| Parameters | Value | Unit |
|---|---|---|
| a | 3.5~14 | micrometer |
| b | 150~400 | micrometer |
| c | 0~1.5 | micrometer |
| S | Light field | none |
| | direction | |
| SiN width | 200~300 | nanometer |
| SiN height | 200~300 | nanometer |
| ARC thickness | 100~200 | nanometer |
| θ | 45 or 35.26 | degree |

The parameter a, as shown in FIG. 2, is the height of the mirror 13 from the frontside surface of the substrate 11, and is in μm.

The parameter b, as shown in FIG. 2, is the thickness of the substrate 11, and is in μm.

The parameter c, as shown in FIG. 2, is the distance of the anti-reflection layer 21 to the (e.g., near end of) the spot size converter 12, and is in μm.

The parameter S denotes the direction of the light field, indicated by the arrows in FIG. 2.

The SiN width is the width of the spot-size converter 12 and is in nm (e.g., direction along the y-axis of the coordinate system in FIG. 2).

The SiN height is the width of the spot-size converter 12 and is in nm (e.g., direction along the z-axis of the coordinate system in FIG. 2).

The ARC thickness is the thickness of the anti-reflection layer 21 and is in nm (e.g., direction along the x-axis of the coordinate system in FIG. 2).

The angle θ is the above-mentioned angle provided between the vertical and sloped surface(s) of the mirror 13, is shown in FIG. 2, and is in degrees.

FIG. 3 shows a system including the integrated photonic chip 10 according to the present disclosure (e.g., as described above) and the optical device 100.

The optical device 100 includes at least one alignment structure 101, which is configured to align the optical device 100 with the photonic chip 10. The photonic chip 10 may include at least one alignment structure 31, which is arranged on or formed in the backside surface of the substrate 11, and is configured to align the photonic chip 10 with the optical device 100.

As shown in FIG. 3, the optical device 100 further includes a collimation lens 102. When the optical device 100 is aligned with the photonic chip 10 as shown, the collimation lens 102 may be configured (e.g., arranged) to receive the collimated light beam 15c output by the photonic chip 10, and to focus the light beam 15d into an optical fiber 103 or an on-device waveguide of the optical device 100. The optical fiber 103 may include a cladding 104, a core 103 between the cladding 104, and a coating 105 around the cladding 104.

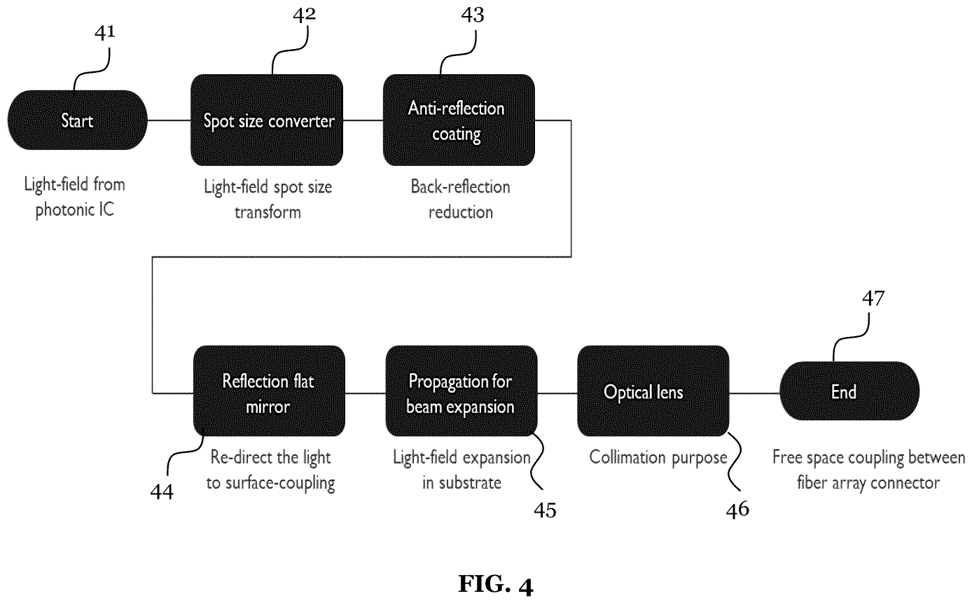

FIG. 4 provides a general functioning of the photonic chip 10 from the perspective of the light. Initially (block 41), there is a light-field from the photonic chip 10, e.g., the light beam 15a may be generated in and/or transmitted to the photonic chip 10.

Then (block 42), the optical light field confined in the photonic chip 10, e.g., in a waveguide thereof, is launched into the spot size converter 12 for enlarging the light mode field diameter (MFD). The enlarged MFD and its intensity distribution are determined by the dimension(s) and material of the spot size converter 12.

The optical light field is set to propagate through the anti-reflection layer 21 (block 43), e.g., formed as a dielectric thin-film layer. The layer 21 may be provided as an anti-reflection coating layer for reducing the reflection between different material interfaces, such as a silicon and/or silicon oxide interface (Si and/or SiO₂).

The optical light field (e.g., then) hits the mirror 13 (block 44), which reflects the light toward a certain direction, for example, for surface-coupling towards the backside surface of the substrate 11. The material of the mirror 13 may be (e.g., presented by) crystalline silicon, and the angle of the mirror 13 may be determined by the silicon lattice orientations during the fabrication process. The mirror 13 may provide (e.g., almost) wavelength independent reflection, so the system may break through spectral bandwidth limitations. A metal coating may be applied for the protection of the mirror surface.

Because the light MFD from the spot size converter 12 is small, the light exhibits (e.g., large) divergence after the reflection. The light may propagate in the substrate 11 to expand the light MFD (block 45).

The expanded light beam is (e.g., then) collimated by the optical meta-lens 14 (block 46), and may (e.g., then) be output from the photonic chip 10 for free space coupling between the photonic chip 10 and the optical device 100, e.g., a fiber array connector.

Due to the reciprocal property of the light field, the photonic chip 10 may also receive optical signals from the optical device 100, e.g., the fiber array connector, so the interface may be adapted as both a transceiver and receiver.

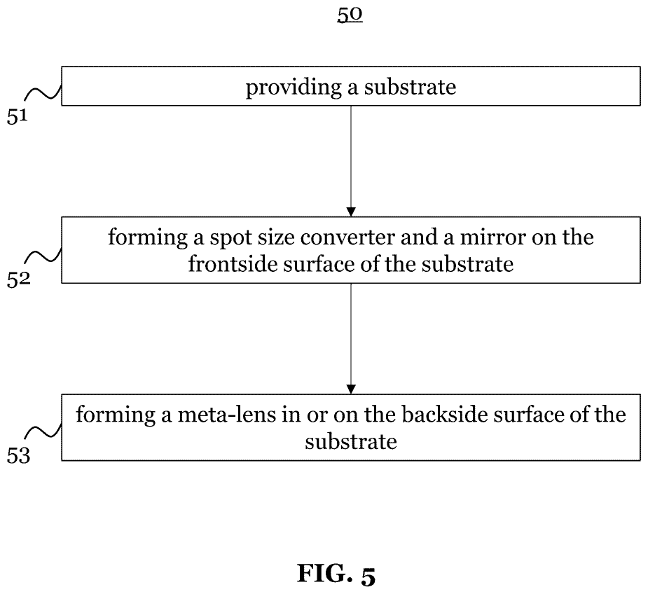

FIG. 5 shows a flow-chart of a (e.g., general) method 50 for fabricating the photonic chip 10. The method 50 includes a step 51 of providing the substrate 11, a step 52 of forming the spot size converter 12 and the mirror 13 on the frontside surface of the substrate 11, and a step 53 of forming the meta-lens 14 in or on the backside surface of the substrate 11.

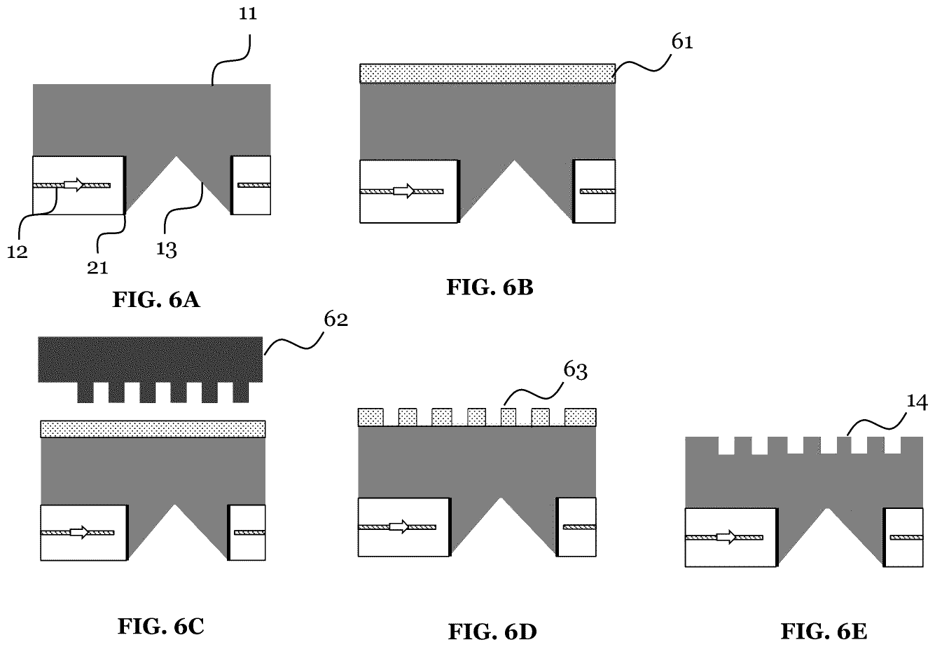

FIGS. 6A, 6B, 6C, 6D, and 6E show example steps for processing the meta-lens 14 of the photonic chip 10. FIG. 6A provides that the frontside processing of the spot size converter 12 and the mirror 13, with the anti-reflection layer 21, is (e.g., already) done. The backside processing of FIG. 6 may be done before the frontside processing.

Forming the meta-lens 14 includes a step of forming a resist layer 61 on the backside surface of the substrate 11, as shown in FIG. 6B. The resist layer 61 may be spin-coated onto the substrate 11. Then, the processing of the meta-lens 14 includes a step of patterning the resist layer 61, for example, by nano-imprinting 62, as shown in FIG. 6C. Nano-imprinting is a high-precision lithographic technique to create nanoscale patterns (e.g., a periodic pattern) on surfaces by mechanically pressing a structured mold onto a material (e.g., here onto the resist). Further, the processing of the meta-lens 14 includes a step of etching the patterned resist layer 63 (shown in FIG. 6D) to form a structure for the meta-lens 14 in the backside surface of the substrate 11 (shown in FIG. 6E). The etching may be a dry etch.

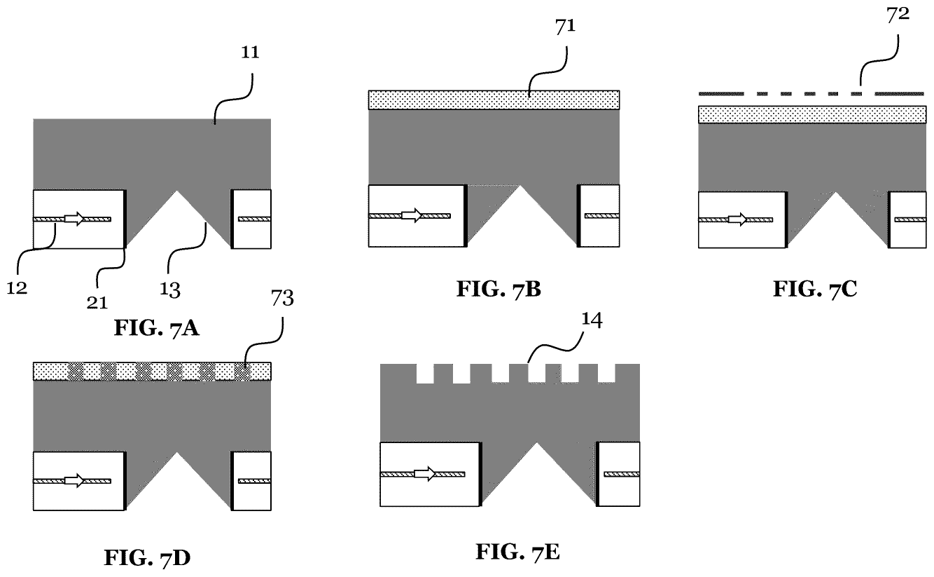

FIGS. 7A, 7B, 7C, 7D, and 7E also show example steps for processing the meta-lens 14 of the photonic chip 10, wherein FIG. 7 shows an alternative process to FIG. 6. FIG. 7A provides that the frontside processing of the spot size converter 12 and the mirror 13, with the anti-reflection layer 21, is (e.g., already) done. The backside processing of FIG. 7 may be done before the frontside processing.

Forming the meta-lens 14 includes a step of forming a resist layer 71 on the backside surface of the substrate 11, as shown in FIG. 7B. The resist layer 71 may be spin-coated onto the substrate 11. Then, the processing of the meta-lens 14 includes a step of patterning the resist layer 71 (e.g., in this case by photo-lithography using a mask), as shown in FIG. 7C. This is followed by a step of developing the resist (e.g., after illumination through the mask), as shown in FIG. 7D, wherein the resist layer 71 is patterned. The patterned resist layer 73 may further be used as a hard mask to pattern the substrate backside surface into the structure for the meta-lens 14, as shown in FIG. 7E.

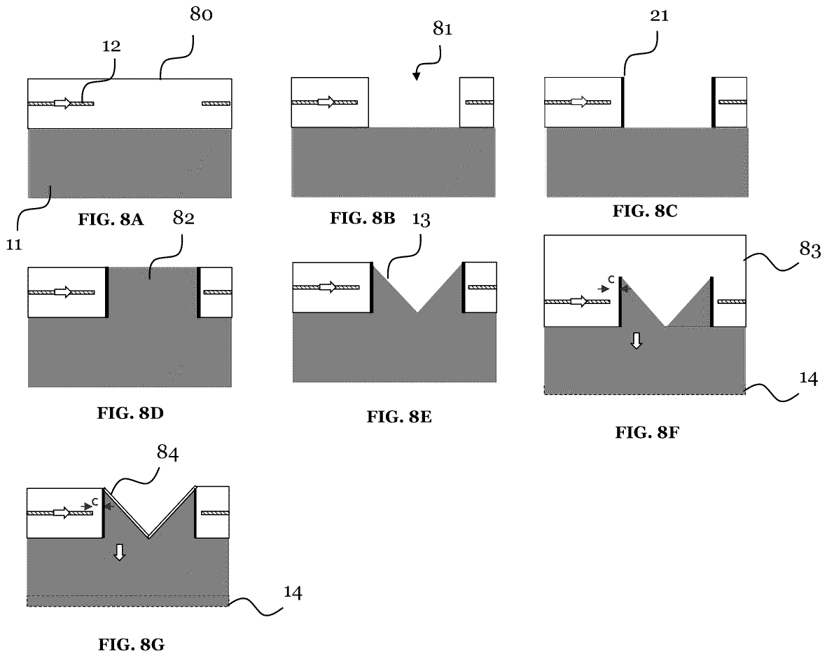

FIG. 8 shows example steps for processing the mirror 13 of the photonic chip 10. The processing includes a step of forming a trench 81 through a dielectric layer 80, which is formed on the frontside surface of the substrate 11 (shown in FIGS. 8A and 8B), onto the substrate 11. Alternatively, the trench 81 may be formed into the substrate 11. The substrate 11 may be made of silicon.

If the trench 81 is formed through the dielectric layer 80, as shown in FIG. 8B, then the anti-reflection layer 21 may be formed on the exposed sidewalls of the dielectric layer 80 within the trench 81, as shown in FIG. 8C. Further, crystalline silicon 82 may be epitaxially grown into the trench 81, as shown in FIG. 8D. Then, the epitaxially grown silicon 82 may be wet etched to form at least one sloped surface of the mirror 13, as shown in FIG. 8E. Further, the mirror 13 may be refilled with dielectric material 83, as shown in FIG. 8F, and/or may be coated with a reflective coating 84 also acting as protection, as shown in FIG. 8G.

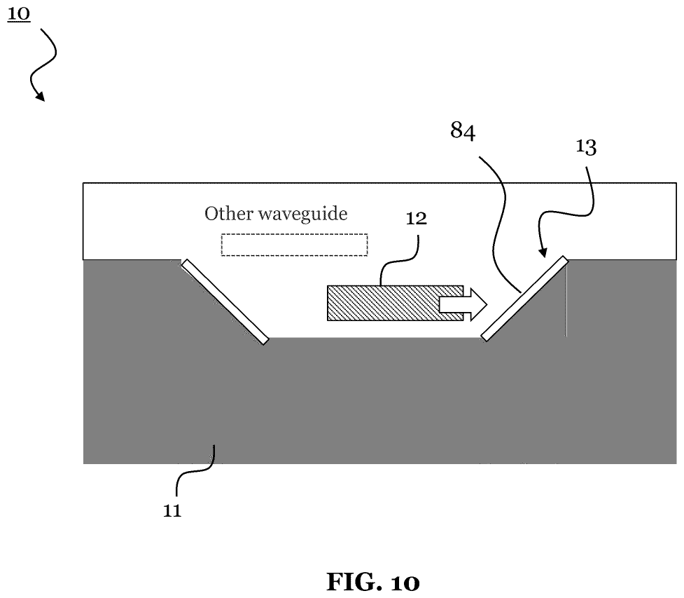

Alternatively, if the trench 81 is formed into the substrate 11, the silicon substrate 11 including the trench 81 may be wet etched, to form the at least one sloped surface of the mirror 13. A possible resulting structure with the spot size converter 12 and mirror 13 including reflective coating 84 is shown in FIG. 10.

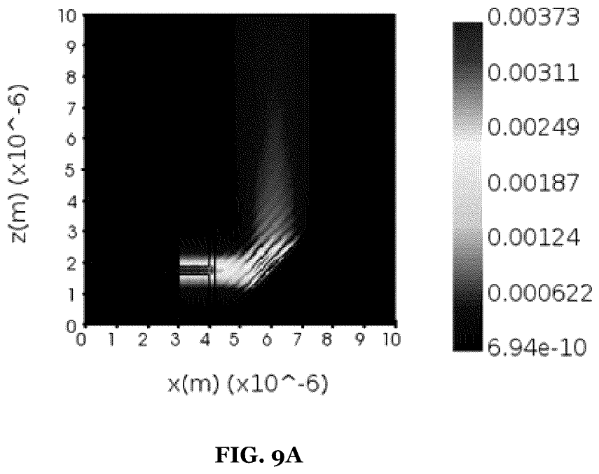

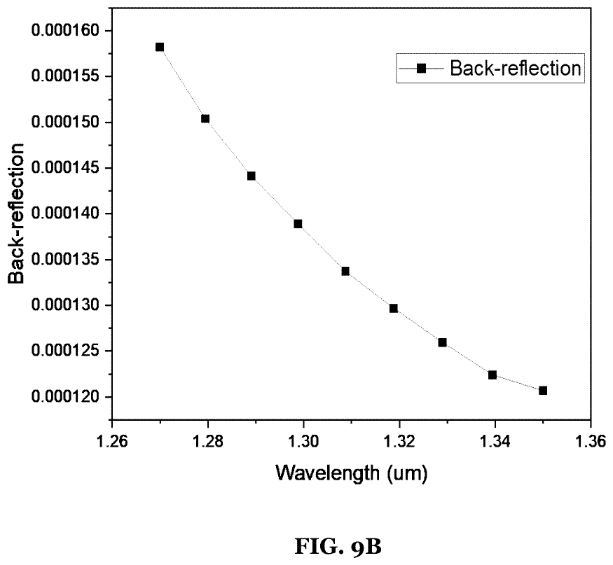

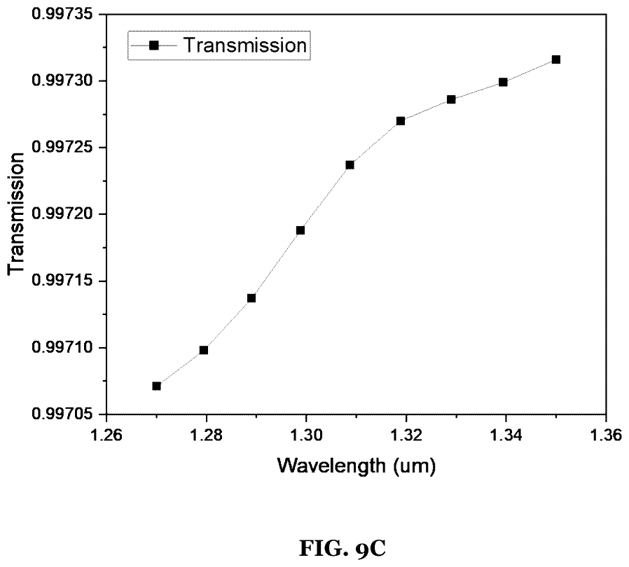

For verification of the photonic chip 10, a series of simulations based on finite-difference time domain (FDTD) were carried out. FIG. 9A shows the simulated intensity profile of the light field for the cross-section view of the photonic chip 10 shown in FIG. 2. The z-direction is flipped for keeping positive propagation direction in the modelling. As shown, the light-field is reflected vertically when the mirror 13 is set to 45°.

FIG. 9B shows the efficiency spectrum for the mirror 13, indicating what portion of the light is vertically reflected. Most light is reflected (e.g., effectively), the loss at wavelength of 1310 nm is (e.g., only) 0.03 dB. FIG. 9C shows the back-reflection spectrum. With single or double layers for optimizing the anti-reflection layer 21, the back-reflection may be controlled. The efficiency spectrum shows a (e.g., very) flat spectrum with (e.g., almost) wavelength independent tendency.

For characterizing the photonic chip 10 experimentally, a free space optical detector can measure the light field intensity. The far field measurement or conversion can also be conducted for determining (e.g., defining) the divergence of the light field. The relevant parameters may include the mode-field diameter, divergence, integrated power, and/or intensity distribution of the light field. A tunable laser source and precise multi-axis tunable stages may be used to set up the measurement.

In summary, the present disclosure provides a surface-coupling interface between a photonic chip 10 and an optical device 100, such as a fiber array connector. The present disclosure integrates a photonic waveguide reflection mirror 13 with a micro-optical collimation meta-lens 14 to provide a more compact photonic chip 10 with improved coupling performance and a simplified integration flow to fabricate the photonic chip 10.

In the present disclosure, the word “comprising” does not exclude other elements or steps, and the indefinite article “a” or “an” does not exclude a plurality. A single element may fulfill the functions of several entities or items recited in the claims. The mere fact that certain measures are recited in mutual different dependent claims does not indicate that a combination of these measures may not be used in an example embodiment.

While some embodiments have been illustrated and described in detail in the appended drawings and the foregoing description, such illustration and description are to be considered illustrative and not restrictive. Other variations to the disclosed embodiments can be understood and effected in practicing the claims, from a study of the drawings, the disclosure, and the appended claims. The mere fact that certain measures or features are recited in mutually different dependent claims does not indicate that a combination of these measures or features cannot be used. Any reference signs in the claims should not be construed as limiting the scope.

What is claimed is:

1. An integrated photonic chip for optical coupling to an optical device, the integrated photonic chip comprising:
a substrate;
a spot size converter formed on a first surface of the substrate and configured to enlarge a diameter of a light beam in the integrated photonic chip from a first size to a second size, wherein the second size is larger than the first size;
a mirror formed on the first surface of the substrate and configured to receive the light beam with a diameter of the second size, from the spot size converter, and to reflect the light beam at an angle into the substrate; and
a meta-lens formed in or on a second surface of the substrate and configured to collimate the light beam reflected by the mirror and expanded, when passing through the substrate, and to output the light beam towards the optical device.

2. The integrated photonic chip according to claim 1, further comprising
a first anti-reflection layer arranged in an optical path of the light beam between the spot size converter and the mirror.

3. The integrated photonic chip according to claim 1, further comprising a second anti-reflection layer arranged in or on the second surface of the substrate.

4. The integrated photonic chip according to claim 1, wherein the spot size converter and the mirror are embedded in a dielectric layer arranged on the first surface of the substrate.

5. The integrated photonic chip according to claim 1, wherein the mirror is made of crystalline silicon, epitaxial silicon, or a silicon part of the substrate.

6. The integrated photonic chip according to claim 1, wherein the mirror comprises a first vertical surface facing toward the spot size converter and a first sloped surface facing away from the spot size converter.

7. The integrated photonic chip according to claim 6, wherein the first anti-reflection layer is an anti-reflection coating on the first vertical surface and facing the spot size converter.

8. The integrated photonic chip according to claim 6, wherein the mirror comprises a second vertical surface facing away from the spot size converter and a second sloped surface facing toward the spot size converter, wherein the first sloped surface and the second sloped surface are arranged between the first vertical surface and the second vertical surface.

9. The integrated photonic chip according to claim 6, wherein an angle between the first vertical surface and the first sloped surface is determined by a crystalline orientation of a material of the mirror or is in a range of about 35° to about 45°.

10. The integrated photonic chip according to claim 8, wherein an angle between the second vertical surface and the second sloped surface is determined by a crystalline orientation of a material of the mirror or is in a range of about 35° to about 45°.

11. The integrated photonic chip according to claim 1, wherein
the spot size converter comprises a tapered waveguide or a wavefront shaping element.

12. The integrated photonic chip according to claim 1, wherein the spot size converter is made of silicon nitride, silicon, or silicon oxynitride.

13. The integrated photonic chip according to claim 1, wherein the meta-lens comprises a periodic patterning of the second surface of the substrate.

14. The integrated photonic chip according to claim 1, further comprising at least one alignment structure arranged on or formed in the second surface of the substrate, wherein the at least one alignment structure is configured to align the integrated photonic chip with the optical device.

15. A system comprising an integrated photonic chip and an optical device, wherein the optical device comprises:
at least one alignment structure configured to align the optical device with the integrated photonic chip; and
a collimation lens configured to receive a collimated light beam output by the integrated photonic chip and to focus a light beam into an optical fiber or an on-device waveguide of the optical device, when the optical device is aligned with the photonic chip.

16. A method for fabricating an integrated photonic chip, the method comprising:
providing a substrate;
forming a spot size converter and a mirror on a first surface of the substrate; and
forming a meta-lens in or on a second surface of the substrate.

17. The method according to claim 16, wherein forming the mirror comprises:
forming a trench through a dielectric layer formed on a first surface of the substrate, or forming a trench into the substrate.

18. The method according to claim 17, wherein the substrate is made of silicon.

19. The method according to claim 18, further comprising:
epitaxially growing crystalline silicon into the trench, when the trench is formed through the dielectric layer;
wet etching the epitaxially grown crystalline silicon grown into the trench or wet etching the substrate comprising the trench, to form at least one sloped surface of the mirror; and
coating the at least one sloped surface of the mirror with a reflective coating.

20. The method according to claim 16, wherein forming the meta-lens comprises:
forming a resist layer on the second surface of the substrate;
patterning the resist layer by nano-imprinting; and
etching the patterned resist layer to form a structure for the meta-lens in the second surface of the substrate.
